(19) United States
(12) Patent Application Publication
(10) Pub. No.: US 2021/0144283 A1
(43) Pub. Date: May 13, 2021

(54) AN APPARATUS, METHOD, AND SYSTEM FOR CAPTURING 360/VIRTUAL REALITY VIDEO USING A MOBILE PHONE ADD-ON

(71) Applicant: Kshitij MARWAH, Bangalore (IN)

(72) Inventor: Kshitij MARWAH, Bangalore (IN)

(21) Appl. No.: 16/488,279

(22) PCT Filed: Jul. 26, 2017
(86) PCT No.: PCT/IN2017/050305

§ 371 Date: Aug. 23, 2019

(30) Foreign Application Priority Data
Feb. 23, 2017 (IN) 201741006538

(51) Int. Cl. H04N 5/225; H04N 5/232; G06T 3/40; G06T 5/00; H04N 5/235; H04N 5/262

(52) U.S. Cl. CPC H04N 5/2257; H04N 5/23238; H04N 5/2621; G06T 5/009; H04N 5/2353; G06T 3/4038

(57) ABSTRACT

A 360-degree Virtual Reality Snap-On Camera that can be connected to any mobile device using the micro-USB, USB-C connector or Lightning connector along with the corresponding mobile application to capture 360-degree and Virtual Reality (VR) Videos is provided. The device consists of two or more cameras with a high-field of lenses connected through a microcontroller or microprocessor. The streams are interpreted, decoded and analyzed by the mobile application through the microcontroller or microprocessor, and mapped by inbuilt Graphics Processing Unit optimized stitching and blending method for a 360-degree VR video experience. The method can perform VR facial filters, VR Avatars and Augmented Reality spatial tracking over the VR Streams. The stream can be further compressed using optimized method for delivery over the cloud networks and can then be shared across social networks, live streamed and viewed either stand-alone or with a VR headset.

### BACKGROUND OF THE INVENTION

Virtual reality (VR) is a technology where headsets are used, occasionally with the physical spaces or multi-projected environments, to create natural images, audios and other sensations that produce a user's actual existence in an imaginary environment. A person making use of the virtual reality technology can feel the virtual environment, and with the use of high-quality VR, the user can move and interact with virtual features. The VR headsets are the head-mounted goggles along with a screen in front of the eyes. The programs in the headsets may include audio and sound through speakers or headphones.

Various applications of Virtual Reality includes Sports, Arts, Entertainment, Medicine, and Architecture. The Virtual Reality helps us to do something that is risk taking, costly and impossible and is used by a range of people like trainee fighter pilots to medical applications trainee surgeons, to experience the real world is in the virtual world. Virtual reality can take us to some brand new and thrilling findings in these fields which affect our daily lives. The concepts such as Google Cardboard, Samsung GearVR, and Epson Movario are already in the lead, but there are players like Meta, Avegant Glyph, Daqri and Magic Leap who are catching up and can very soon surprise the industry with new heights of involvement and operation.

The components of VR are display, positional tracking, graphics processing, logic processing, input devices, reality engine, and audio units.

There has been an advent of 360-degree and Virtual Reality camera technologies in the last few years. Most of these cameras are bulky, stand-alone products at an unaffordable price point. For Virtual Reality cameras to become mainstream, there is a need for small, sleek, portable form factors that can fit on a mobile device for a complete social 360-degree and Virtual Reality experience. The invention 360-degree VR capture is an apparatus that records the video or image. It consists of a 360-degree Virtual Reality Snap-On Camera that can be connected to the mobile. The mobile recognizes the camera when plugged in. The mobile application starts the recording with the help of an apparatus that contains two, or more than two camera sensors. After the recording is done, the videos or the image can be shared online. The 3D video can also be converted to 2D. The video when saved on the mobile can be viewed later by the mobile application or by any VR headset.

### FIELD OF THE INVENTION

The invention proposes an apparatus, method, and system for capturing a 360-degree and Virtual Reality Video using a mobile phone add-on.

### DISCUSSION OF PRIOR ART

U.S. Pat. No. 7,583,288 B2 titled “Panoramic Video” describes a process that generates a scene's panoramic video. There is a computer to get the various videos, which were captured using different cameras. A camera rig is used to record the video of the scene with the cameras recording mode, which spans through the 360-degree view of the scene. After the video is recorded, the frames are stitched together. A texture map is created for each frame which relates to the scene's environment model. To transfer the video and to view it, the frame's representation of the texture map is encoded. The encoding can deal with the compression of the video frames, which is helpful when the panoramic video has to be sent online.

US 2007/0229397 A1 titled “Virtual Reality System” describes a system that deals with Virtual Reality that consists of a device for playing back the images and sending the images to the device for viewing images like display glasses. The user can only view a part of the image, and the part of the image that is viewed is determined by a directional sensor that is on the display glasses. The images move to the next with the help of the speed sensor that is fixed to any moving device, for example, a stationary bicycle. The Virtual Reality system organizes those parts of the image that is viewed by the user, by taking the signals both from the direction and speed sensor, respectively. The user can also command the system which plays back the images, depending on the directional sensor's position.

U.S. Pat. No. 9,674,435B1 titled “Virtual Reality platforms for capturing content for Virtual Reality displays” describes three different types of systems that create databases which help the Virtual Reality apparatus for display. The system consists of pairs of a three-dimensional camera, two types of microphones which are airborne and conduction, two types of sensors that are physical and chemical, Central Processing Unit (CPU) and some other electronics. The databases can be used at that very time or saved for future use. The artefacts that may disturb the Virtual Reality experience of the audience are removed. The system made is such that it covers multidimensional audio content, multidimensional video content, along with physical and chemical content. These systems are set up inside a designated venue to gather the Virtual Reality content.

U.S. Pat. No. 6,084,979 titled “Method for creating Virtual Reality” describes a method of creating the Virtual Reality. The Virtual Reality is created with the help of images related to a real event. The images are captured with more than one camera, placed at more than one angles. Every image has the two values stored that is intensity and color information. An internal representation is created from the images and the information related to the angles. Any image of any time and from any angle can be created using the internal representation. For the three-dimensional effect, the viewpoints can be shown on a Television screen or any display device. The event can be handled and interacted with the help of any Virtual Reality system.

U.S. Pat. No. 8,508,580 B2 titled “Methods, Systems, and computer-readable storage media for creating three-dimensional (3D) images of a scene” describes a method for creating three-dimensional images from a scene, by getting more than one image of the scene. The attributes of the image are also determined. From all the images, a pair of the image is selected based on the attributes of the image to construct a three-dimensional image. For receiving different images of the scene, there has to be an image-capture device. The process of converting an image into a three-dimensional image includes choosing correct pair of images, register the images, correcting them, correcting the colors, transformation, and the process of depth adjustment, detecting motion and finally the removal.

### SUMMARY OF THE INVENTION

In the present invention, a new 360-degree and Virtual Reality Snap-On Camera can be connected to any mobile device using the Micro Universal Serial Bus (USB), USB-C connector or Lightning connector along with the corresponding mobile application to capture 360-degree and Virtual Reality (VR) videos. The device consists of two or more cameras with a high-field of view lenses that are connected through a microcontroller or microprocessor. The microprocessor/controller streams the two or more stream through the micro-USB, USB-C connector or Lightning connector on the mobile phone. The streams are interpreted, decoded and analyzed by the mobile application, which then runs Graphics Processing Unit (GPU)-optimized methods for the live stitching and blending of the corresponding streams for a seamless 360-degree and Virtual Reality video experience. Simultaneously, VR filters, avatars can be added to the content along with the depth map computations for the scene understanding and holographic viewing. This video can be shared across social networks, live streamed and viewed either as stand-alone or with a Virtual Reality headset with depth perception.

The device includes two or more camera sensors placed at varied angles from each other for a complete 360-degree and VR view capture. A wide field of the lens that covers as much area based on their field of view is present in each camera. A microcontroller or a microprocessor-based board is used to encode and transfer the stream of these multiple cameras to the mobile phone. A Micro Universal Serial Bus (USB), USB-C connector or Lightning connector connects the stream to the mobile phone. A mobile application decodes, remap and blend these varied streams into one seamless 360-degree and Virtual Reality videos for sharing across the social networks.

In this invention, a device for capturing 360-degree and visual representation having two or more cameras comprising an enclosure, two or more cameras, two or more cameras, a PCB Board, a connector, and a controller. The enclosure houses cameras, lenses, printed circuit boards, and other elements which include resistors, capacitors, LDOs and other electronic elements in the device. The two or more cameras that are frame by frame synced along with the high-field of lenses for maximum coverage. The two or more cameras that visually sense the world around and transmit an uncompressed visual representation of the world. The PCB Board has a micro-controller along with other elements that compress, encode and transmit the visual data stream to the mobile phone. The connector enables communication with a mobile phone.

The controller is configured for the following, to detect when the camera is snapped onto the mobile phone, to stitch and blend one or more visual representations camera and lens parameters along with scene context to take two or more camera streams and combine them into a single 360-degree or true Virtual Reality output, to enhance one or more visual representations to correct exposure, contrast and compress before further processing, to perform spatial tracking and filtering, to share visual representations to all social networks, to edit one or more visual representations including Virtual Avatars, 2D Stickers over 360-degree or Virtual Reality Streams, 3D Stickers over tracked 360 or Virtual Reality Streams, to view one or more visual representations in perspective, orthographic, little planet, equirectangular or other projections, to stream one or more visual representations over a cloud infrastructure, and to compute one or more depth maps using a configuration of two or more cameras, the mobile application also computes a depth map of the scene using Graphics Processing Unit (GPU)-optimized multi-view stereo matching that can be used for holographic transmission of data. The visual representation is one or more images or one or more video data streams.

The controller is further configured to, blend and stitch visual representations such that they are optimized for a Graphics Processing Unit (GPU) using camera and lens parameters along with scene context to take two or more camera streams and combine them into a single 360-degree, true Virtual Reality output, enhance one or more visual representations to correct exposure, contrast and compress before live streaming or saving it, perform spatial tracking and filtering using VR filters, lenses and avatars such that the saved, streamed 360-degree Virtual Reality (VR)

Stream can be enhanced with facial filters over VR streams, virtual avatars and Spatial Augmented Reality (AR) tracking over 360-degree and VR streams for true Mixed Reality viewing, share visual representations to all social networks also supporting live streaming of content over one or more communication networks, edit one or more visual representations by using an intelligent video editing feature that allows automatic editing of 360-degree videos to make one simple experience for the moments, view one or more visual representations by utilizing a built-in 360-degree and Virtual Reality (VR) Video viewer that can be used to swipe and view 360-degree videos, and stream one or more visual representations over a cloud infrastructure wherein one or more cloud servers compress the 360-degree and Virtual Reality streams and then decode the compressed streams through the 360-degree and Virtual Reality Viewer on client end. Further, the controller is further configured to edit one or more visual representations by using a video editing feature that can also project 360-degree videos into the 2D space to make for a normal flat-screen video experience and to share visual representations over a VR headset with depth perception, to create an immersive experience. The enclosure is made of plastic or metal.

The method for capturing 360-degree and visual representation having two or more cameras comprising stitching, blending, Mixed Reality enhancement and Visual-Inertial SLAM tracking. The stitching, blending further comprising of, in-memory decoding of frames from synced camera streams, computing overlaps between different camera streams based on lens parameters, camera matrix, and low-level scene understanding, and stitching for a seamless 360-degree or Virtual Reality Video, applying blending and feather techniques on overlapped frames for exposure correction, color, and contrast correction, and the resultant 360-degree or Virtual Reality video is projected using mono or stereo orthographic, perspective, equirectangular or little planet view forms. The Mixed Reality enhancement further comprising, taking input as 360-degree or Virtual Reality content, detecting facial features and overlaying with the virtual avatars that can be viewed on a Smartphone or a VR headset by taking input as 360-degree or Virtual Reality content, projecting multi-dimensional stickers to a spherical domain for users to swipe including 360-degree monoscopic content and move their VR headset to view these augmentations using the 360-degree or Virtual Reality Viewer, and using Visual-Inertial SLAM based tracking over 360-degree VR Streams and augmenting tracked holograms thereby allowing for creation and sharing of true Mixed Reality content. The Visual-Inertial SLAM tracking further comprising, initialization the Visual system of the Smartphone, including multiple cameras, the initialization of Inertial System of the Smartphone, including Inertial Measurement Unit (IMU) that contains an accelerometer, gyroscope, and magnetometer, pre-processing and normalization of all camera(s) and IMU data, detection of features in a single or multiple cameras streams, detecting keyframes in camera frames and storing them for further processing, estimation of 3D world map and camera poses using non-linear optimization on the keyframe and IMU data, improving the 3D map and estimating one or more camera estimation using Visual-Inertial alignment, Loop Closure Model along with GPU-optimized implementation for real-time computations, and rendering Augmented Reality content on the Smartphone based on camera pose and 3D Map estimation on Smartphone Display.

In the present invention, a method for capturing 360-degree and visual representation having two or more cameras comprising the steps of, detecting the application automatically through use of the connector and powering-up with the help of a mobile phone battery, viewing one or more live streams as 360-degree Virtual Reality on a mobile phone camera, recording 360-degree Virtual Reality in either image or video form, forwarding captured media to various social networks for sharing, activating automatic editing of the video from 360-degree or Virtual Reality to 2D, additionally, and repeating the previous steps for a new recording, also either viewing of the previous videos or sharing or editing.

### BRIEF DESCRIPTION OF THE DRAWINGS

FIG. 1 illustrates the top view of one version of the device with two cameras.

FIG. 2 illustrates a side view of one version of the device with two cameras.

FIG. 3 illustrates a front view of one version of the device with two cameras.

FIG. 4 illustrates the isometric view of one version of the device with two cameras.

FIG. 5 illustrates the diametric view of the one version of the device with two cameras.

FIGS. 6a and 6b illustrates the half section view of the one version of the device with two cameras.

FIGS. 7a and 7b illustrates the sectional view of the one version of the device with two cameras.

FIG. 8 illustrates the isometric view of another version of the device with four cameras.

FIG. 9 illustrates the front view of another version of the device with four cameras.

FIG. 10 illustrates a side view of another version of the device with four cameras.

FIG. 11 illustrates a back view of another version of the device with four cameras.

FIG. 12 illustrates the working of the device along with the Smartphone.

FIG. 13 illustrates the Virtual Reality concept.

FIG. 14 illustrates the entire process of this invention.

FIG. 15 illustrates the Stitching and Blending, Mixed Reality enhancement and Visual-Inertial SLAM tracking methods.

### DETAILED DESCRIPTION OF THE PREFERRED EMBODIMENTS

FIG. 1 is the top view. This version of the device consists of two cameras sensors (1, 2) that have a high-field of view lenses. These cameras (1, 2) are connected to a microcontroller or microprocessor-based board for encoding and transmission of these streams through the required connector on any mobile device.

FIG. 2 illustrates a side view of one version of the device with two cameras. The PCB 3 consists of a microcontroller or a microprocessor along with other elements that compress, encode and transmit the visual data stream to the mobile phone. There is a connector 4 which can either be a micro-USB, USB-C connector or Lightning connector to transmit streams to the mobile phone along with the two cameras (5, 6).

FIG. 3 illustrates the front view of one version of the device with two cameras. There is a connector 8 which can either be a micro-USB, USB-C connector or Lightning connector to transmit streams to the mobile phone along with the two cameras 7.

FIG. 4 illustrates the isometric view of one version of the device with two cameras. There is a connector 10 which can either be a micro-USB, USB-C connector or Lightning connector to transmit streams to the mobile phone along with the camera 9.

FIG. 5 illustrates the diametric view of the one version of the device with two cameras. There is a plastic or metal enclosure 11 which houses lens, printed circuit boards, camera sensors and other electronics. There are dual camera sensors 12 along with the custom Image Signal Processor (ISP) for the synced frame output, along with the dual high-field of view lenses 13 for the complete 360-degree coverage to be done. There is a connector 14 which can either be a micro-USB, Type-C USB or Lightning connector that works with any Smartphone.

FIGS. 6a and 6b illustrates the half section view of the one version of the device with two cameras. There is a connector 16 which can either be a micro-USB, USB-C connector or Lightning connector to transmit streams to the mobile phone along with the camera 15 in FIG. 6a. In FIG. 6b, the half section view of the version of the device with two cameras is shown with a high-field of view aligned lenses 19 for the maximum 360-degree coverage. There is a custom printed circuit board (PCB) 17 with Internet Service Provider (ISP) for streaming the high-resolution dual sensor 18 image data. The high throughput camera sensor 18 combined with the ISP drives 360-degree or Virtual Reality Stream over a USB Interface, with the connector 20.

FIGS. 7a and 7b illustrates the sectional view of the one version of the device with two cameras. There is a connector 22 which can either be a micro-USB, USB-C connector or Lightning connector to transmit streams to the mobile phone along with the camera 21 in FIG. 7a. In FIG. 7b, the sectional view of the version of the device with two cameras is shown with the connector 23.

FIG. 8 shows an isometric view of another version of the device with four cameras. This version of the device consists of four high-field of lenses 24 for each scene point to be seen by two cameras, four high-resolution sensors 25 with on-board dual-ISPs for true Virtual Reality content streaming and a connector 26 which can either be a micro-USB, USB-C connector or Lightning connector for plugging into any Smartphone.

FIG. 9 shows the front view of another version of the device with four cameras. This version consists of four cameras sensors (27, 28) each having a high-field of lenses. All cameras (27, 28) are connected to a microcontroller or microprocessor-based board for encoding and transmission of these streams through the required connector 29 on any mobile device.

FIG. 10 illustrates a side view of another version of the device with four cameras. The PCB 32 consists of a microcontroller or a microprocessor along with other elements that compress, encode and transmit the visual data stream to the phone. There are two cameras (30, 31) sensors along with the connector 33 which can either be a micro-USB, USB-C connector or Lightning connector to transmit streams to the mobile phone.

FIG. 11 illustrates a back view of another version of the device with four cameras. There are four cameras (34, 35, 37, 38) sensors along with the connector 36 which can either be a micro-USB, USB-C connector or Lightning connector to transmit streams to the mobile phone.

FIG. 12 illustrates the working of the device with the Smartphone. The dual-camera 39 360-degree VR Camera or True VR camera 39 can be attached onto a Smartphone 40. The viewer can use the mobile application 41 with the finger swipe interaction to look around the whole 360-degree image.

FIG. 13 illustrates the Virtual Reality concept. The mobile application 42 in the Smartphone is used for the stereo display with the content shot using a 360-degree or Virtual Reality camera. The Virtual Reality headset 43 can be used to see the 360-degree or Virtual Reality content.

The hardware components of the 360-degree and Virtual Reality viewing device are individually described below:

Enclosure: A plastic or metal enclosure 11 houses the cameras, lenses 13, the printed circuit boards and other elements which include resistors, capacitors, LDOs and other electronic elements in the device as shown FIG. 5.

Cameras: FIG. 1 and FIG. 9 shows two or more cameras that are frame by frame synced along with the high-field of lenses for maximum coverage. Two or more cameras (1, 2, 27, 28) visually sense the world around and transmit an uncompressed image or video data stream.

Lenses: For each camera, there are a high-field of view lenses (as in FIG. 1 and FIG. 9) that can cover as much area to make sure that the device can have a complete 360-degree×360-degree field of view.

PCB Board: FIG. 2 and FIG. 10 shows the PCB (3, 32) that consists of a micro-controller or a microprocessor along with other elements that compress, encode and transmit the visual data stream to the mobile phone.

Connector to Mobile Phone: FIG. 3 and FIG. 11 shows a micro-USB, USB-connector or Lightning connector (8, 36) that transmits the stream to the mobile phone.

Individual software components of the 360-degree and Virtual Mixed reality viewing device are:

Mobile Application: A mobile application (41, 42) with a seamless user interface that detects when the camera is snapped onto the mobile phone.

An inbuilt method for stitching and blending: A Graphics Processing Unit (GPU)-optimized method that uses the camera and lens parameters along with the scene understanding, to take two or more camera streams and combine them into a single 360-degree or true Virtual Reality output. Video enhancement is performed over this output to correct the exposure, contrast and compress before live streaming or saving it.

VR filters, lenses, avatars and Spatial tracking: The saved or streamed 360-degree Virtual Reality (VR) Stream can be enhanced with the facial filters over the VR streams, virtual avatars and Spatial Augmented Reality (AR) tracking over 360-degree and VR streams for true Mixed Reality viewing.

The detailed Stitching and Blending A, and Mixed Reality enhancement B methods are described in FIG. 15, the steps comprising of:

STEP I: The method starts 109 with in-memory decoding of the frames from the synced camera streams 110.

STEP II: Based on the lens parameters, camera matrix, and the low-level scene understanding, computing overlaps 111 between the different camera streams and stitching for a seamless 360-degree or Virtual Reality Video.

STEP III: Blending and feather techniques are applied 112 on the overlapped frames for the exposure correction, color, and contrast correction.

STEP IV: The resultant 360-degree or Virtual Reality video is projected using either mono or stereo orthographic, perspective, equirectangular or little planet view forms 113.

STEP V: Taking input as 360-degree or Virtual Reality content by the Mixed Reality enhancement B, and detecting the facial features and overlaying with the Virtual Avatars that can be viewed on a Smartphone or a VR headset 114.

STEP VI: Using the 360-degree or Virtual Reality Viewer, for projecting the 2D or 3D Stickers to the spherical domain for the users to swipe (360-degree monoscopic content) and move their VR headset (360-degree stereoscopic content) to view these augmentations 115.

STEP VII: Using the Visual-Inertial SLAM based tracking over the 360-degree VR Streams tracked holograms can be augmented allowing for the creation and sharing of true Mixed Reality content 116, and the method ends 117.

Further, the detailed Visual-Inertial SLAM based tracking method C of STEP VII comprises of:

STEP i: Initialization of the Visual system 118 of the Smartphone that includes, mono or dual cameras or any other external cameras as attached.

STEP ii: Initialization of Inertial system 119 of the Smartphone, including Inertial Measurement Unit that contains an accelerometer, a gyroscope, and a magnetometer.

STEP ii: The process of pre-processing and normalization 120 of all cameras and IMU data.

STEP iv: The pre-processing and normalization is followed by detection of features 121 in a single or multiple cameras streams.

STEP v: The keyframes within camera frames are identified 122 and are stored for further processing.

STEP vi: Estimation of the 3D world map and camera pose, using non-linear optimization on the keyframe and IMU data 123.

STEP vii: The 3D map and camera pose estimation are enhanced by employing Visual-Inertial Alignment, Loop Closure Model along with the GPU-optimized implementation for real-time computations 124.

STEP vii: The rendering of Augmented Reality content on Smartphone based on camera pose and 3D Map estimation on Smartphone Display is done 125.

Social sharing and live streaming: The mobile application has an inbuilt social sharing feature, over all the social networks. The application also supports live streaming of content over Wi-Fi or Telecom networks.

Automatic video editing: The mobile application has an intelligent video editing feature that allows automatic editing of the 360-degree videos to make one simple experience for the moments. The video editing feature can also project the 360-degree videos into the 2D space to make for a normal flat-screen video experience.

360-degree and Virtual Reality Video Viewer: The application has an inbuilt 360-degree and Virtual Reality (VR) Video viewer that can be used to swipe and see the 360-degree videos or can be put on a VR headset for an immersive experience.

Optimized cloud infrastructure for 360-virtual reality streaming: The Cloud servers can compress the 360-degree and Virtual Reality streams with a multiple fold savings in data bandwidths. The resulting compressed streams can then be decoded through the 360-degree and Virtual Reality Viewer on the client end.

Depth map computations: Using a configuration of two or more cameras, the mobile application also computes a depth map of the scene using the Graphics Processing Unit (GPU)-optimized multi-view stereo matching that can be used for holographic transmission of data.

FIG. 14 illustrates the entire method of the invention. The process for a 360-degree and Virtual Reality view is as follows:

STEP I: The process starts 100 by connecting the device to a mobile phone. The device uses a device connector to automatically detect the mobile phone application 101 and uses the mobile phone battery to power itself 102.

STEP II: The mobile application on the mobile phone is powered on. A live stream can be seen in 360-degree and Virtual Reality of the camera on the mobile phone 103 along with 360-degree and Virtual Reality real-time depth map computed via Graphics Processing Unit (GPU)-optimized method of the scene is also transmitted.

STEP III: A 360-degree and Virtual Reality can be recorded either in an image or video form and can be enhanced using custom VR filters, lenses, and spatial tracking over VR streams 104.

STEP IV: The resulting content can then be forwarded to various social networks such as Facebook, Twitter, Instagram, YouTube, Snapchat, Hike and other platforms for sharing 107. A live stream in 360-degree and Virtual Reality is also possible over the Cloud Backend or incumbent social platforms 105.

In addition to the above process, the device can activate automatic editing of the video from the 360-degree and Virtual Reality to 2D 106. Further, the above steps can be repeated for a new recording session or the previous videos can be viewed or shared or edited 108.

1. A device for capturing 360-degree and visual representation having two or more cameras comprising:
a. An enclosure 11 that houses cameras, lenses, printed circuit boards and other elements which include resistors, capacitors, LDOs and other electronic elements in the device;
b. Two or more cameras, that are frame by frame synced along with high-field of lenses, for maximum coverage;
c. Two or more cameras, that visually sense the world around and transmit an uncompressed visual representation of the world;
d. A PCB Board having a micro-controller along with other elements that compress, encode and transmit the visual data stream to the mobile phone;
e. A connector that enables communication with a mobile phone; and
f. A controller, wherein the controller is configured to:
i. Detect when the camera is snapped onto the mobile phone;
ii. Stitch and blend one or more visual representations camera and lens parameters along with scene context to take two or more camera streams and combine them into a single 360-degree or true Virtual Reality output;
iii. Enhance one or more visual representations to correct exposure, contrast and compress before further processing;
iv. Perform spatial tracking and filtering;
v. Share visual representations to all social networks;
VI. Edit one or more visual representations including Virtual Avatars, 2D Stickers over 360-degree or Virtual Reality Streams, 3D Stickers over tracked 360 or Virtual Reality Streams;
VII. View one or more visual representations in perspective, orthographic, little planet, equirectangular or other projections; vm. Stream one or more visual representations over a cloud infrastructure; and
IX. Compute one or more depth maps using a configuration of two or more cameras, the mobile application also computes a depth map of the scene using Graphics Processing Unit (GPU)-optimized multi-view stereo matching that can be used for holographic transmission of data.

2. The device of claim 1, wherein the visual representation is one or more images.

3. The device of claim 1, wherein the visual representation is one or more video data streams.

4. The device of claim 1, wherein the controller is further configured to:
a. Blend and stitch visual representations such that they are optimized for a Graphics Processing Unit (GPU) using camera and lens parameters along with scene context to take two or more camera streams and combine them into a single 360-degree, true Virtual Reality output;
b. Enhance one or more visual representations to correct exposure, contrast and compress before live streaming or saving it;
c. Perform spatial tracking and filtering using VR filters, lenses and avatars such that the saved, streamed 360-degree Virtual Reality (VR) Stream can be enhanced with facial filters over VR streams, virtual avatars and Spatial Augmented Reality (AR) tracking over 360-degree and VR streams for true Mixed Reality viewing;
d. Share visual representations to all social networks also supporting live streaming of content over one or more communication networks; e. Edit one or more visual representations by using an intelligent video editing feature that allows automatic editing of 360-degree videos to make one simple experience for the moments;
f. View one or more visual representations by utilizing a built-in 360-degree and Virtual Reality (VR) Video viewer that can be used to swipe and view 360-degree videos; and
g. Stream one or more visual representations over a cloud infrastructure wherein one or more cloud servers compress the 360-degree and Virtual Reality streams and then decode the compressed streams through the 360-degree and Virtual Reality Viewer on client end.

5. The device of claim 1, wherein the controller is further configured to edit one or more visual representations by using a video editing feature that can also project 360-degree videos into the 2D space to make for a normal flat-screen video experience.

6. The device of claim 1, wherein the controller is further configured to share visual representations over a VR headset with depth perception, to create an immersive experience.

7. The device of claim 1, wherein the enclosure 11 is made of plastic.

8. The device of claim 1, wherein the enclosure is made of metal.

9. A method for capturing 360-degree and visual representation having two or more cameras comprising stitching, blending (A), Mixed Reality enhancement (B) and Visual-Inertial SLAM tracking (C) comprising the steps of:
a. Stitching, blending (A) further comprising:
i. In-memory decoding of frames from synced camera streams 110;
ii. Computing overlaps between different camera streams based on lens parameters, camera matrix, and low-level scene understanding; and stitching for a seamless 360-degree or Virtual Reality Video;
iii. Applying blending and feather techniques on overlapped frames for exposure correction, color, and contrast correction; and iv. The resultant 360-degree or Virtual Reality video is projected using mono or stereo orthographic, perspective, equirectangular or little planet view forms;
b. Mixed Reality enhancement (B) further comprising:
i. Taking input as 360-degree or Virtual Reality content, detecting facial features and overlaying with the virtual avatars that can be viewed on a Smartphone or a VR headset by taking input as 360-degree or Virtual Reality content;
ii. Projecting multi-dimensional stickers to a spherical domain for users to swipe including 360-degree monoscopic content and move their VR headset to view these augmentations 115 using the 360-degree or Virtual Reality Viewer; and
iii. Using Visual-Inertial SLAM based tracking over 360-degree VR Streams and augmenting tracked holograms thereby allowing for creation and sharing of true Mixed Reality content; and
c. Visual-Inertial SLAM tracking C further comprising:
i. Initialization the Visual system of the Smartphone, including multiple cameras;
ii. The initialization of Inertial System of the Smartphone, including Inertial Measurement Unit (IMU) that contains an accelerometer, gyroscope, and magnetometer;
iii. Pre-processing and normalization of all cameras and MU data iv. Detection of features in a single or multiple cameras streams; v. Detecting keyframes in camera frames and storing them for further processing;
vi. Estimation of 3D world map and camera poses using non-linear optimization on the keyframe and IMU data;
vii. Improving the 3D map and estimating one or more camera estimation using Visual-Inertial alignment, Loop Closure Model along with GPU-optimized implementation for real-time computations; and
viii. Rendering Augmented Reality content on the Smartphone based on camera pose and 3D Map estimation on Smartphone Display.

10. The method for capturing 360-degree and visual representation having two or more cameras comprising the steps of:
a. Detecting the application automatically through use of the connector and powering-up with the help of a mobile phone battery;
b. Viewing one or more live streams as 360-degree Virtual Reality on a mobile phone camera;
c. Recording 360-degree Virtual Reality in either image or video form;
d. Forwarding captured media to various social networks for sharing; e. Activating automatic editing of the video from 360-degree or Virtual Reality to 2D, additionally; and
f. Repeating the previous steps for a new recording, also either viewing of the previous videos or sharing or editing.
